(19) United States
(12) Patent Application Publication
(10) Pub. No.: US 2025/0323589 A1
(43) Pub. Date: Oct. 16, 2025

(54) MOTOR CONTROL APPARATUS, MOTOR CONTROL METHOD, AND STORAGE MEDIUM

(71) Applicant: CANON KABUSHIKI KAISHA, Tokyo (JP)

(72) Inventors: HIROFUMI HONDA, Tokyo (JP); KOTA UCHIYAMA, Tokyo (JP)

(21) Appl. No.: 19/090,937

(22) Filed: Mar. 26, 2025

(30) Foreign Application Priority Data
Apr. 12, 2024 (JP) 2024-065018

(51) Int. Cl. H02P 8/32; G02B 7/04

(52) U.S. Cl. CPC H02P 8/32; G02B 7/04

(57) ABSTRACT

A motor control apparatus comprises an encoding unit configured to detect a rotation state of a motor and convert the rotation state into actual position information, a target position setting unit configured to generate a target position counter value serving as a movement target of a driven member connected to the motor, and an advance angle control unit configured to control a rotation speed of the motor based on a target advance angle, wherein the advance angle control unit comprises a target speed calculation unit configured to calculate a target speed that is an amount of change of the target position counter value, a target advance angle calculation unit configured to calculate the target advance angle corresponding to the target speed based on correspondence information between the rotation speed and the advance angle, a target advance angle corresponding to the target speed, a position deviation correction amount calculation unit configured to calculate a position deviation correction amount from a deviation amount between the actual position information and the target position counter value, and an advance angle correction amount calculation unit configured to convert the position deviation correction amount into a speed deviation correction amount and calculate, from the correspondence information between rotation speed and advance angle, an advance angle correction amount corresponding to the speed deviation correction amount, wherein position control of the driven member is performed using the target advance angle corrected by the advance angle correction amount.

### BACKGROUND OF THE INVENTION

### Field of the Invention

The present invention relates to a motor control apparatus, a motor control method, a storage medium, and the like.

### Description of the Related Art

A proposal has been made for controlling the advance angle of a driving waveform with respect to the rotational phase of a motor and efficiently driving the motor. According to this method, by controlling the advance angle so that the advance angle becomes optimal and by suppressing unnecessary torque, it becomes possible to rotationally drive the motor efficiently, thereby enabling higher speed and lower vibration.

In addition, Japanese Patent Laid-Open No. 2001-045780 proposes realizing speed control by setting a target advance angle corresponding to a target speed based on a corresponding characteristic between advance angle and speed, and controlling the driving voltage in accordance with the deviation of the actual speed with respect to the target speed.

Furthermore, Japanese Patent Laid-Open No. 2021-083196 performs advance angle control in which torque is reduced as the distance to the target position decreases by setting the deviation between a current position and the target position as the advance angle value in a case in which the deviation is within a range in which an advance angle is settable.

In addition, in an image capturing lens configured by a plurality of lenses, in order to move the plurality of lenses in conjunction with each other in a predetermined positional relationship during zooming, a tracking-type position control is required to move the lenses by following a target position that moves at an arbitrary speed.

However, in the configuration of Japanese Patent Laid-Open No. 2001-045780, when speed control is performed by updating the target advance angle in accordance with the moving speed of the target position, it is not possible to perform accurate tracking-type position control because a deviation from the target position occurs due to response delay, disturbance, and the like.

In addition, although the configuration of Japanese Patent Laid-Open No. 2021-083196 is applicable to fixed-type position control for quickly moving to a target position, because the configuration is not configured so as to perform speed control in accordance with a moving speed of the target position, stable following performance cannot be obtained in tracking-type position control.

### SUMMARY OF THE INVENTION

A motor control apparatus according to one aspect of the present invention comprises an encoding unit configured to detect a rotation state of a motor and convert the rotation state into actual position information, a target position setting unit configured to generate a target position counter value that serves as a movement target of a driven member connected to the motor, and an advance angle control unit configured to control a rotation speed of the motor based on a target advance angle, wherein the advance angle control unit comprises a target speed calculation unit configured to calculate a target speed that is an amount of change of the target position counter value, a target advance angle calculation unit configured to calculate the target advance angle corresponding to the target speed based on correspondence information between the rotation speed and the advance angle, a position deviation correction amount calculation unit configured to calculate a position deviation correction amount from a deviation amount between the actual position information and the target position counter value, an advance angle correction amount calculation unit configured to convert the position deviation correction amount into a speed deviation correction amount and calculate an advance angle correction amount corresponding to the speed deviation correction amount from the correspondence information between the rotation speed and the advance angle, wherein position control of the driven member is performed using the target advance angle corrected by the advance angle correction amount.

Further features of the present invention will become apparent from the following description of embodiments with reference to the attached drawings.

### BRIEF DESCRIPTION OF THE DRAWINGS

FIG. 1A is a figure showing an exemplary schematic configuration of an image capturing lens according to a First Embodiment of the present invention. FIG. 1B is a figure showing a trajectory of a focus lens according to the First Embodiment of the present invention.

FIG. 2A and FIG. 2B are figures showing an exemplary schematic configuration of a motor unit according to the First Embodiment of the present invention.

FIG. 3 is a functional block diagram showing an exemplary configuration of a lens control system according to the First Embodiment of the present invention.

FIG. 4 is a figure showing exemplary processing of an encoder 305 according to the First Embodiment.

FIG. 5 is a figure showing an exemplary relationship between advance angle and motor rotation speed according to First Embodiment.

FIG. 6 is a figure showing a flow of processing of an advance angle control unit 308 and a driving waveform generation unit 309 according to the First Embodiment of the present invention.

FIG. 7A is a figure showing a state in which a position detection counter value indicating an actual position has deviated from a target position counter value.

FIG. 7B is a figure showing a state in which a deviation has occurred between a target speed (an inclination of a target position counter value 7-b-1) and an actual speed (an inclination of a position detection counter value 7-b-2).

FIG. 7C is a figure explaining position control using an advance angle.

FIG. 8 is a functional block diagram showing an exemplary configuration of the advance angle control unit 308 for realizing position control using an advance angle according to the First Embodiment.

FIG. 9 is a flowchart showing an example of advance angle control processing according to the First Embodiment.

FIG. 10 is a flowchart showing an example of target advance angle calculation processing in step S910.

FIG. 11 is a flowchart showing an example of speed deviation adjustment amount calculation processing in step S911.

FIG. 12 is a flowchart showing an example of relational expression update processing in step S912.

FIG. 13 is a flowchart showing an example of position deviation correction amount calculation processing in step S914.

FIG. 14 is a flowchart showing an example of advance angle correction processing in step S915.

FIG. 15A and FIG. 15B are figures showing examples of changes in an encoder and an advance angle with respect to a target position counter value according to the First Embodiment of the present invention.

FIG. 16 is a flowchart showing an example of advance angle control by the advance angle control unit 308 according to a Second Embodiment.

FIG. 17 is a flowchart showing a specific example of position deviation correction coefficient update processing in step S1601.

FIG. 18 is a flowchart showing an example of advance angle correction processing in step S1602 according to the Second Embodiment.

FIG. 19A and FIG. 19B are figures showing examples of changes in an encoder and an advance angle in a case in which reversal prevention processing is applied according to the Second Embodiment.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

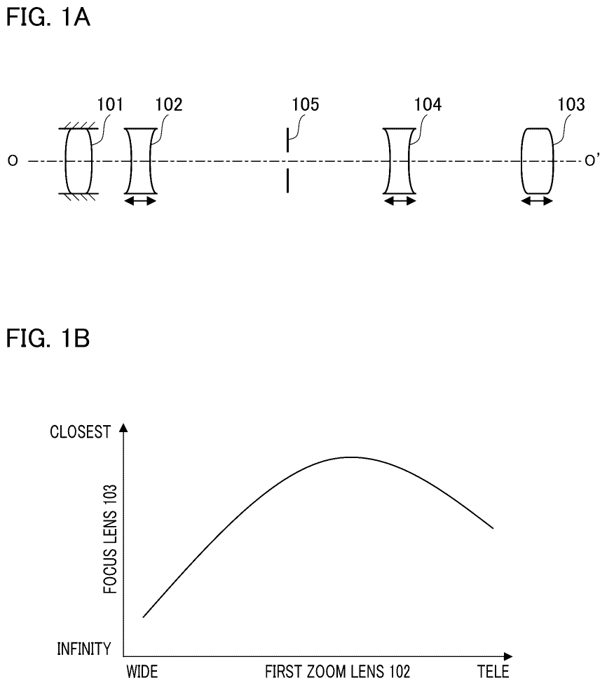

FIG. 1A is a figure showing an exemplary schematic configuration of an image capturing lens according to a First Embodiment of the present invention. FIG. 1B is a figure showing a trajectory of a focus lens according to the First Embodiment of the present invention. The image capturing lens is configured by a fixed lens 101, a first zoom lens 102, a focus lens 103, a second zoom lens 104, an aperture stop 105, and the like, and the image capturing lens performs magnification variation by moving a plurality of lenses in conjunction with each other according to a predetermined positional relationship.

The first zoom lens 102 performs zooming by moving in an optical axis direction (a direction along O—O′). The focus lens 103 has both a function of correcting movement of a focal plane accompanying zooming and a focusing function, and moves in the optical axis direction following a trajectory like that shown in FIG. 1B, for example, in conjunction with movement of the first zoom lens 102. The second zoom lens 104 similarly moves in the optical axis direction following a predetermined trajectory in conjunction with movement of the first zoom lens 102.

In this manner, the image capturing lens includes at least one zoom lens and a focus lens. In addition, a target position counter value of at least one zoom lens is generated so that the zoom lens moves at a target speed, and a target position counter value of the focus lens is generated so that the focus lens moves following a predetermined trajectory in conjunction with movement of the zoom lens.

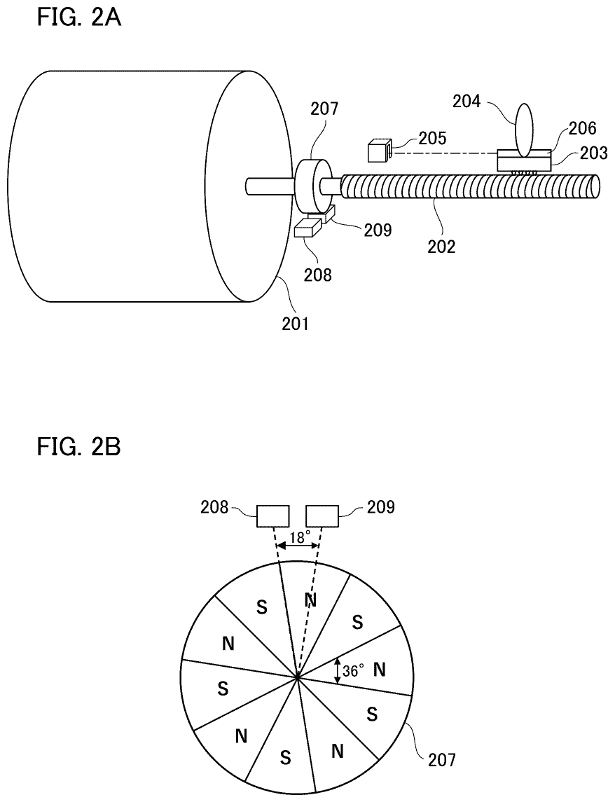

Next, FIG. 2A and FIG. 2B are figures showing an exemplary schematic configuration of a motor unit according to the First Embodiment of the present invention. It should be noted that this motor unit is provided for each lens, and each motor unit operates independently. That is, a plurality of motors are configured so that each motor drives a lens configuring the image capturing lens.

In FIG. 2A, reference numeral 201 denotes a stepping motor, reference numeral 202 denotes a rotation axis of the stepping motor 201, and reference numeral 203 denotes a rack. The rotation axis 202 serves as a lead screw and meshes with the rack 203 so that a lens 204 connected to the rack 203 moves in the optical axis direction in accordance with rotation of the rotation axis 202.

A reference position of the lens is determined by a configuration of a PI (photo-interrupter) 205 arranged on a fixed member (not shown) and a light shielding plate 206 provided to the lens. The PI 205 is configured by a light emitting portion and a light receiving portion, and when the light shielding plate 206 enters between the light emitting portion and the light receiving portion in association with movement of the lens 204, a detection signal of the PI 205 switches from High to Low.

This switching position is set as the reference position of the lens. Reference numeral 207 denotes a cylindrical magnet for rotation phase detection attached to the rotation axis 202, and in combination with rotation phase detection Hall sensors 208 and 209, the rotation phase of the stepping motor 201 is detected (hereinafter, the rotation phase detection Hall sensor 208 is referred to as Hall-Ch0 and reference numeral 209 is referred to as Hall-Ch1).

FIG. 2B is a diagram that explains an arrangement of the rotation phase detection magnet 207 and the rotation phase detection Hall sensors 208 and 209 in a case in which the stepping motor 201 has ten poles. The rotation phase detection magnet 207 is configured by a ten-pole magnet matching the number of motor poles.

Each pole is arranged uniformly at a mechanical angle of 36°. The rotation phase detection Hall sensors 208 and 209 are arranged on an extension line at a mechanical angle of 18° of the rotation phase detection magnet 207. By this configuration, two types of sine waves having phases shifted 90° with respect to each other are detected from each Hall sensor in accordance with rotation of the motor.

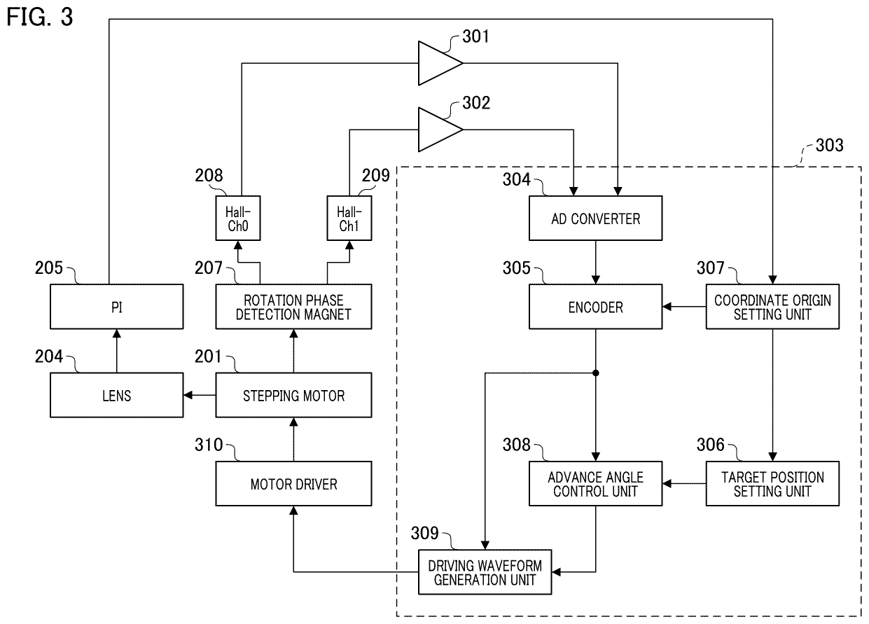

Next, FIG. 3 is a functional block diagram showing an exemplary configuration of a lens control system according to the First Embodiment of the present invention. It should be noted that the present system is set for each lens, and processing is performed independently. Furthermore, part of the functional blocks shown in FIG. 3 are realized by a CPU (not shown), serving as a computer included in the lens control system, executing a computer program stored in a memory (not shown) serving as a storage medium.

However, a part or all of these functional blocks may be realized by hardware. As hardware, a dedicated circuit (ASIC) or a processor (reconfigurable processor, DSP), and the like can be used.

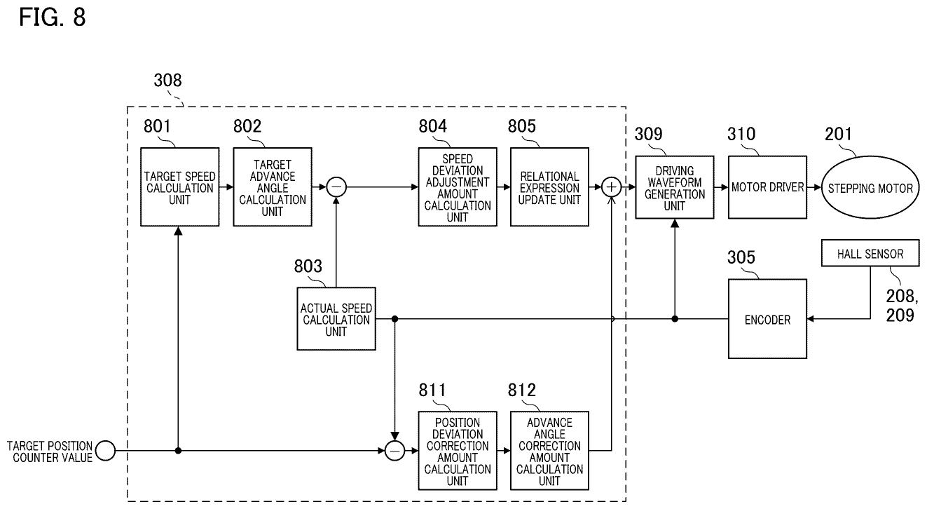

In addition, the respective functional blocks shown in FIG. 3 need not be housed in the same casing, and may be configured by separate apparatuses connected to each other via signal paths. It should be noted that the above explanation with respect to FIG. 3 similarly applies to FIG. 8.

In FIG. 3, blocks having the same reference numerals as in FIG. 2 are identical members. The Hall signal detected by Hall-Ch0 is amplified by an amplifier circuit 301, and the Hall signal detected by Hall-Ch1 is amplified by an amplifier circuit 302. The amplified two-phase Hall signals are then quantized by an AD converter 304 in a motor control apparatus 303, after which a position detection counter value is calculated through encoding processing by the encoder 305.

Reference numeral 306 denotes a target position setting unit that sets a target position of the lens and generates a target position counter value for controlling each lens at a target speed and target position. That is, the target position setting unit 306 in the lens control system connected to the first zoom lens 102 generates a target position counter value so that the zoom speed becomes the target zoom speed. The target position setting unit 306 generates a target position counter value serving as a movement target of a driven member connected to the motor.

In addition, the target position setting unit 306 in the lens control system connected to the focus lens 103 generates a target position counter value so that the focus lens moves following a predetermined trajectory in conjunction with movement of the first zoom lens 102, as shown in the example of FIG. 1B. Furthermore, similarly, a target position counter value is generated so that the second zoom lens 104 moves following a predetermined trajectory in conjunction with movement of the first zoom lens 102.

The target position counter value and the position detection counter value are aligned by setting the same coordinate origin in a coordinate origin setting unit 307. Reference numeral 308 denotes an advance angle control unit in which advance angle and power rate control for driving the motor in order to follow the target position is performed. In addition, the advance angle control unit 308 controls a rotation speed of the motor based on a target advance angle.

Reference numeral 309 denotes a driving waveform generation unit that generates a driving counter value by adding the target advance angle to the position detection counter value, performs SIN/COS conversion on the generated driving counter value, and generates two-phase driving waveforms having amplitudes adjusted according to the power rate.

However, because feedback control cannot be performed until the coordinate origin is set by the coordinate origin setting unit 307, open control is performed. That is, the advance angle control unit 308 sets the target position counter value obtained from the target position setting unit 306 as the driving counter value and performs open control of the driving waveform by setting a power rate for open control.

The driving waveform generated by the driving waveform generation unit 309 is supplied to a motor driver 310 as, for example, a PWM signal, and is converted into a motor driving signal by the motor driver 310 and supplied to the stepping motor 201. It should be noted that the driving waveform may be supplied to the motor driver 310 after AD conversion processing, or may be supplied as driving waveform information from a communication port.

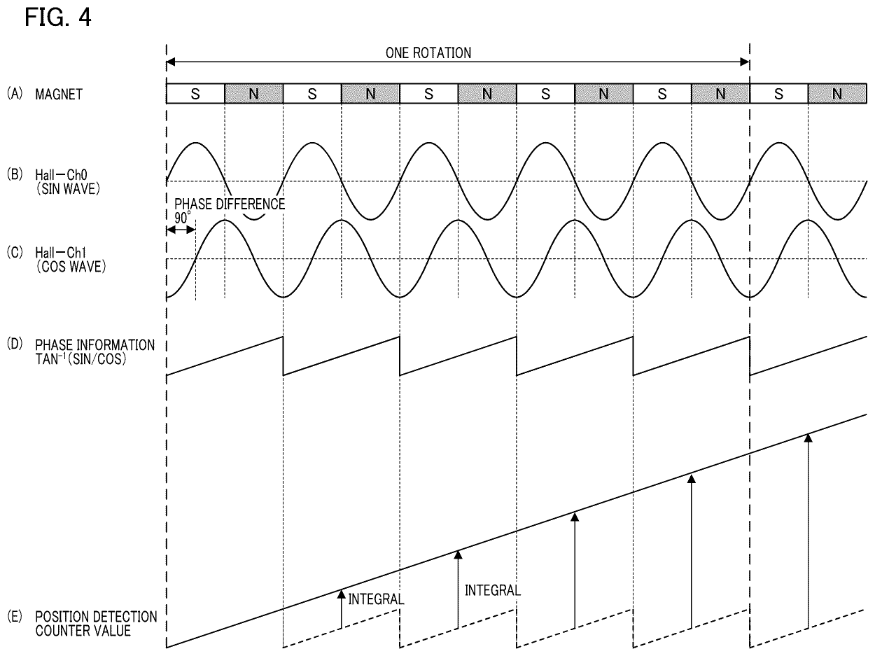

Here, processing of the encoder 305 will be explained in detail by using FIG. 4. FIG. 4 is a figure showing exemplary processing of the encoder 305 according to the First Embodiment. It should be noted that here, consistent with the configuration of FIG. 2B, an explanation will be given for an example in which the stepping motor 201 has ten poles and the rotation phase detection magnet 207 is a cylindrical magnet having ten poles.

In FIG. 4, (A) shows the rotation phase detection magnet 207 of the motor, and (B) and (C) show waveforms of respective Hall signals detected by Hall-Ch0 and Hall-Ch1. By the configuration shown in FIG. 2B, a sine wave (Sin wave) and a cosine wave (Cos wave) having phases shifted by 90° with respect to each other are obtained as Hall signals.

The encoder 305 uses the Sin wave and Cos wave signals, shown in (B) and (C) and quantized by the AD converter 304, to perform an inverse tangent operation (tan⁻¹(Sin/Cos)) and calculate phase information from 0 to 360°.

In FIG. 4, (D) shows the calculated phase information, and a position detection counter value, as shown in (E), that indicates a rotation amount of the motor is calculated by performing integration processing on this calculated phase information. This rotation amount information can be converted into position information of the lens by multiplying the rotation amount information by a screw pitch of the lead screw.

Therefore, the motor rotation amount information calculated by the encoder 305 is handled as a position detection counter value of the lens. That is, the encoder 305 functions as an encoding unit configured to execute an encoding step of detecting a rotation state of the motor and converting the rotation state into actual position information. Here, although the phase information has been explained as information from 0 to 360°, the range is determined by resolution of the position detection counter value and is not limited thereto.

Next, processing of the coordinate origin setting unit 307 will be explained in detail. When power is turned on, the motor control apparatus 303 first executes a coordinate origin setting sequence of the lens.

That is, the lens is driven and a search is performed for the lens position at which the detection signal of the PI 205 explained in FIG. 2 switches from High to Low, and this searched switching position is set as the coordinate origin, whereupon the position detection counter value and the target position counter value are initialized to predetermined values. Thereby, the coordinates of the position detection counter and the target position counter are aligned, enabling performance of control of the lens position.

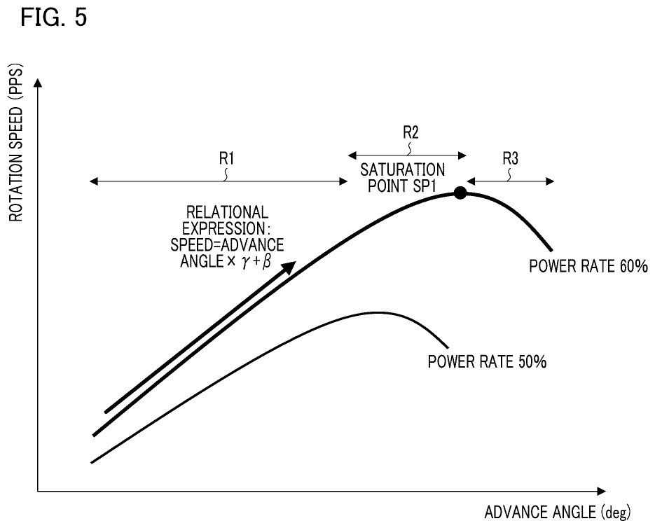

FIG. 5 is a diagram showing an exemplary relationship between advance angle and motor rotation speed according to the First Embodiment, and FIG. 5 shows the relationship between advance angle and motor rotation speed using a case in which a power rate is 60% and a case in which a power rate is 50% as examples. Because the power rate adjusts the amplitude of a driving waveform, for example, a power rate of 60% indicates that the amplitude of the driving waveform is limited to 60%.

In FIG. 5, it can be seen that in region R1, the motor rotation speed increases in proportion to an increase in the advance angle. However, when the advance angle is further increased, the motor rotation speed reaches region R2 in which the increase in motor rotation speed with respect to the advance angle gradually approaches saturation. When the advance angle is further increased and exceeds a saturation point SP1, the motor rotation speed enters region R3 in which the motor rotation speed decreases.

In addition, as the power rate becomes larger, an inclination of advance angle versus motor rotation speed in region R1 becomes steeper, and the saturation point SP1 shifts toward a larger advance angle. The relationship between advance angle and speed becomes a proportional relationship within a range of region R1. That is, the relationship between advance angle and speed can be expressed by the following equation (1). It should be noted that equation (1), serving as a relational expression indicating a correspondence relationship between motor rotation speed with respect to advance angle, functions as correspondence information between the motor rotation speed and the advance angle.

$$Speed = Advance angle \times γ + β \qquad Equation ( 1 )$$

wherein γ is an inclination and β is an offset.

Therefore, the relationship between advance angle and rotation speed is measured in advance, and based on the measurement data, the inclination γ and intercept β of equation (1), and region R1 serving as an effective region of equation (1) corresponding to region R1 are stored as an advance angle versus speed table.

It should be noted that a plurality of advance angle versus speed tables are stored for each power rate and are set to be selectable in accordance with a target speed. In addition, a lower value is preferentially selected for the power rate. Furthermore, although the relationship between advance angle and speed is explained here using equation (1), the correspondence information between motor rotation speed and advance angle may be table data in which the relationship between advance angle and speed is stored in advance.

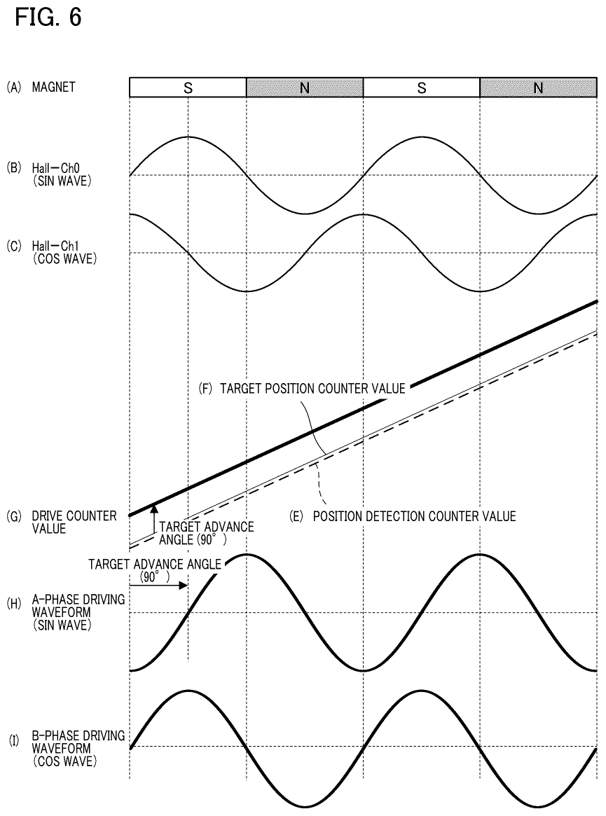

FIG. 6 is a figure showing a flow of processing of the advance angle control unit 308 and the driving waveform generation unit 309 according to the First Embodiment. It should be noted that because in FIG. 6, (A) to (C), and (E) show the same signals as the signals explained with the same reference symbols in FIG. 4, explanations thereof are omitted here. In FIG. 6, (F) shows a target position counter value. As described above, the target advance angle and power rate are calculated so as to make the position detection counter value (E) follow the target position counter value (F).

It should be noted that hereinafter, an explanation will be given using an example of a case in which a target advance angle is 90°. The advance angle control unit 308 generates a drive counter value (G) by superimposing a target advance angle of 90° on the position detection counter value (E).

The position detection counter value (E) is a counter value obtained by integrating phase information from 0 to 360°, and similarly, the driving counter value (G) has phase information of 0 to 360°. Therefore, in the driving waveform generation unit 309, by performing SIN conversion and COS conversion on this driving counter value (G), two-phase driving waveforms of an A-phase driving waveform (Sin wave) (H) and a B-phase driving waveform (Cos wave) (I) that are shifted by the advance angle amount with respect to a motor rotation phase are generated.

In addition, these driving waveforms have power rates set so as to become target amplitudes and are output to the motor driver 310. It should be noted that although the phase information has been explained here as information from 0 to 360°, this range is determined by resolution of the position detection counter value (E) and is not limited thereto.

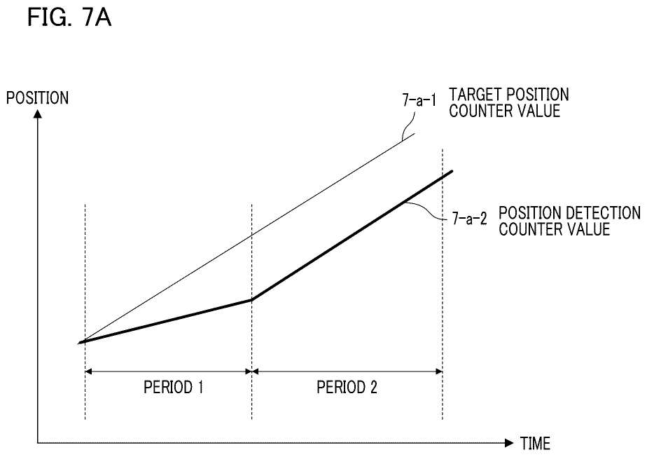

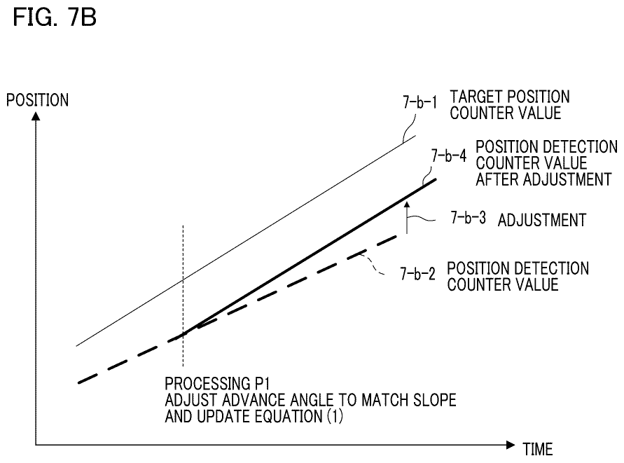

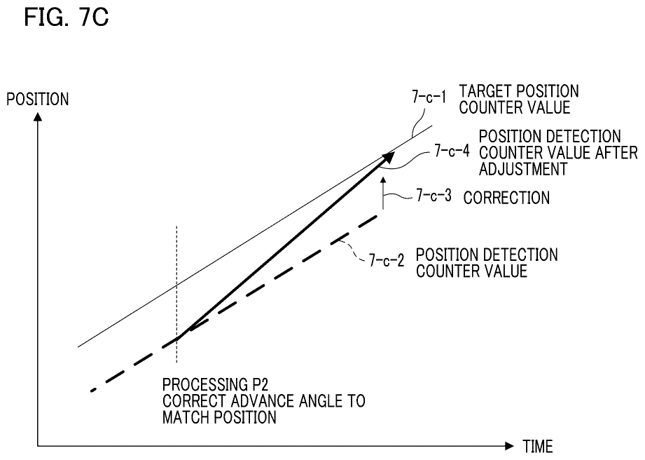

Here, using FIGS. 7A to 7C, an explanation will be given of an example of a method according to the present embodiment for realizing, by using advance angle control, position control that moves a lens by following a target position moving at an arbitrary speed.

FIG. 7A is a figure showing a state in which a position detection counter value that indicates an actual position has deviated from a target position counter value. In interval 1 of FIG. 7A, a speed deviation occurs due to disturbance, load fluctuation, and the like, and FIG. 7A shows a state in which a deviation occurs between a target position counter value shown in 7-a-1 and a position detection counter value shown in 7-a-2. In interval 2 of FIG. 7A, although the speed deviation is resolved, a deviation (position deviation) between the target position counter value and the position detection counter value remains.

That is, by merely adjusting speed by advance angle control, position control for following a counter value of a moving target position cannot be realized.

Therefore, in the present embodiment, position control for following a counter value of a moving target position is realized by advance angle control.

In explaining a control method according to the present embodiment, first, FIG. 7B is a figure showing a state in which a deviation occurs between a target speed (an inclination of target position counter value 7-b-1) and an actual speed (actual speed: an inclination of position detection counter value 7-b-2).

In FIG. 7B, by processing P1, adjustment of the inclination of the position detection counter value is performed as shown in 7-b-3 by adjusting the advance angle so that the actual speed (inclination of position detection counter value 7-b-2) matches the target speed (inclination of target position counter value 7-b-1). Thereby, the position detection counter value after adjustment 7-b-4 is obtained. Next, the inclination γ and intercept β of equation (1) are updated based on the relationship between advance angle and actual speed.

Next, FIG. 7C is a diagram explaining position control using an advance angle. In FIG. 7C, the speed deviation is resolved by processing P1. From this state, by processing P2, the deviation (position deviation) between target position counter value 7-c-1 and position detection counter value 7-c-2 is corrected by correcting the advance angle as shown in 7-c-3. Thereby, the position detection counter value after correction 7-c-4 is obtained, and the above-described position deviation is resolved.

FIG. 8 is a functional block diagram showing an exemplary configuration of the advance angle control unit 308 for realizing position control using an advance angle according to the First Embodiment. It should be noted that in FIG. 8, because identical reference numerals denote identical functional blocks as in FIG. 3, explanations thereof are omitted.

The advance angle control unit 308 includes a target speed calculation unit 801 configured to calculate a target speed from an inclination of a target position counter value, a target advance angle calculation unit 802 configured to calculate a target advance angle from the target speed using the relational expression of equation (1), and an actual speed calculation unit 803 configured to calculate an actual speed from an inclination of a position detection counter value. In addition, the advance angle control unit 308 includes a speed deviation adjustment amount calculation unit 804 configured to calculate a speed deviation adjustment amount from a deviation between the target speed and the actual speed, and a relational expression update unit 805 configured to update the relational expression of equation (1) by adjusting the advance angle.

In addition, the advance angle control unit 308 includes a position deviation correction amount calculation unit 811 configured to calculate a position deviation correction amount from a deviation between the target position counter value and the position detection counter value, and an advance angle correction amount calculation unit 812 configured to calculate an advance angle correction amount from the position deviation correction amount.

The advance angle control unit 308 performs processing P1 for resolving speed deviation and processing P2 for resolving phase deviation (position deviation) by the above described functional blocks. Processing P1 for resolving speed deviation is performed by the target speed calculation unit 801, the target advance angle calculation unit 802, the actual speed calculation unit 803, the speed deviation adjustment amount calculation unit 804, and the relational expression update unit 805. In contrast, processing P2 for resolving phase deviation (position deviation) is performed by the position deviation correction amount calculation unit 811 and the advance angle correction amount calculation unit 812.

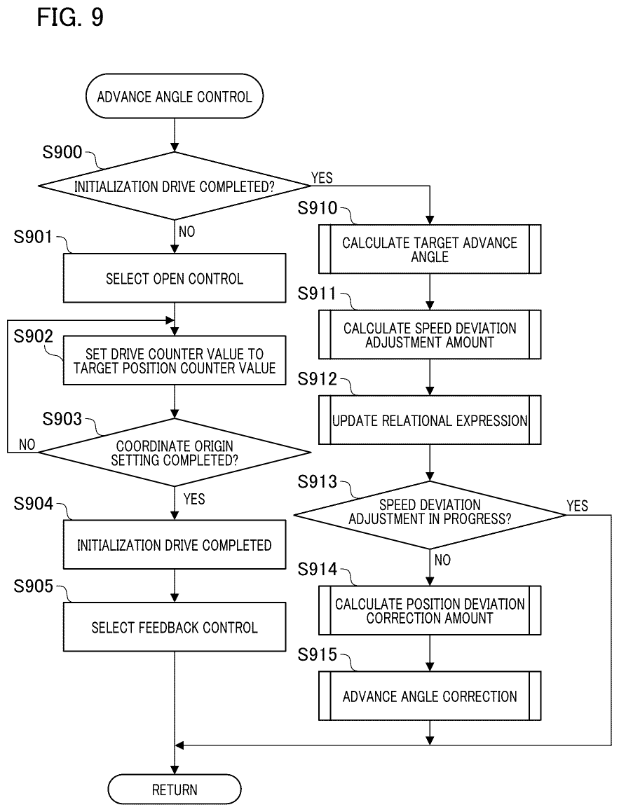

FIG. 9 is a flowchart showing an example of advance angle control processing according to the First Embodiment and shows a detailed example of an advance angle control step of controlling a rotation speed of a motor based on a target advance angle. It should be noted that operations of each step in the flowchart of FIG. 9 are performed sequentially by a CPU or the like serving as a computer in the lens control system executing a computer program stored in memory.

In step S900, the advance angle control unit 308 determines whether initialization driving has been completed. In a case in which “No” is determined in step S900, the processing proceeds to step S901 and open control is selected. Then, in step S902, the motor is driven by open control by setting the target position counter value as a driving counter value. Here, step S902 functions as a target position setting step configured to generate a target position counter value serving as a movement target of the driven member connected to the motor.

Then, when a reference position is detected by the PI 205, an identical coordinate origin is set for the position detection counter value and the target position counter value by the coordinate origin setting unit 307. In step S903, whether coordinate origin setting has been completed is determined, and in a case of “Yes”, that is, when a notification of completion of coordinate origin setting is received from the coordinate origin setting unit 307, an initialization driving completion state is set in step S904, and feedback control is selected in step S905. Thereafter, the processing returns to step S900 and advance angle control is continued.

In contrast, in a case in which an initialization driving completion state is detected in step S900, the processing proceeds to step S910, and a target advance angle is calculated by the target advance angle calculation unit 802. That is, feedback control of position (position control) using an advance angle is started.

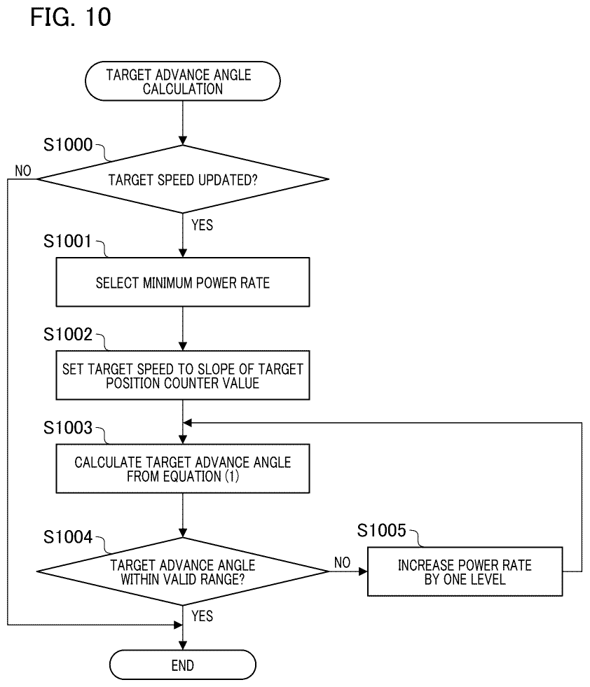

Here, step S910 functions as a target advance angle calculation step of calculating a target advance angle corresponding to a target speed based on equation (1) serving as correspondence information between speed and advance angle. In addition, a detailed example of processing in step S910 will be described later with reference to FIG. 10.

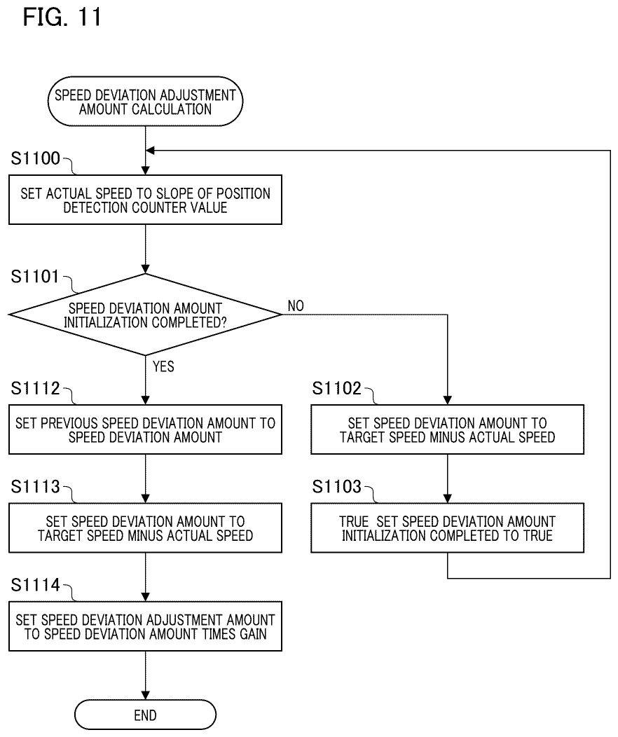

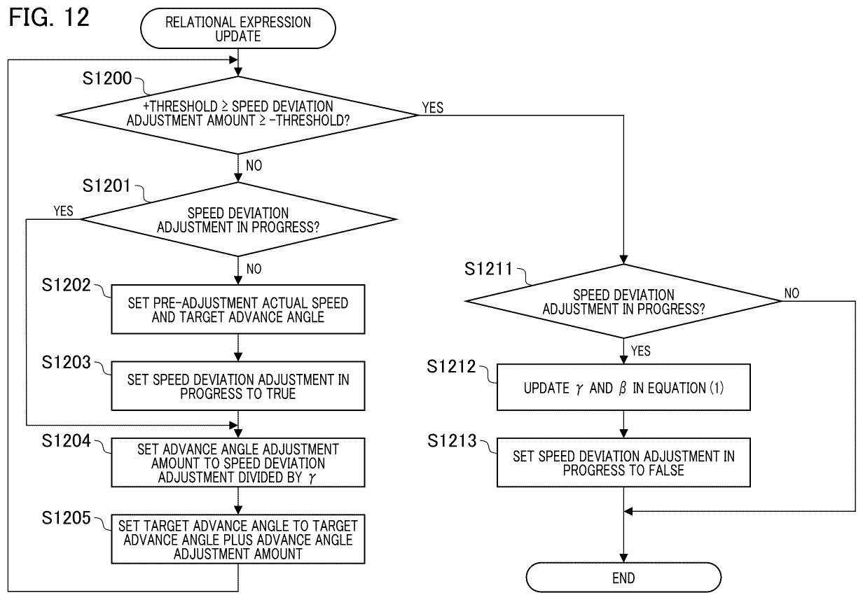

Then in step S911, calculation of a speed deviation adjustment amount is performed by the speed deviation adjustment amount calculation unit 804. A detailed example of processing in step S911 will be described later with reference to FIG. 11. In addition, in step S912, updating of the relational expression is performed by the relational expression update unit 805. A detailed example of processing in step S912 will be described later with reference to FIG. 12.

Furthermore, in step S913, whether or not speed deviation adjustment is being executed is determined and in a case in which “Yes” is determined in step S913, the processing returns to step S900 and continues advance angle control without proceeding to processing to resolve position deviation in steps S914 and S915.

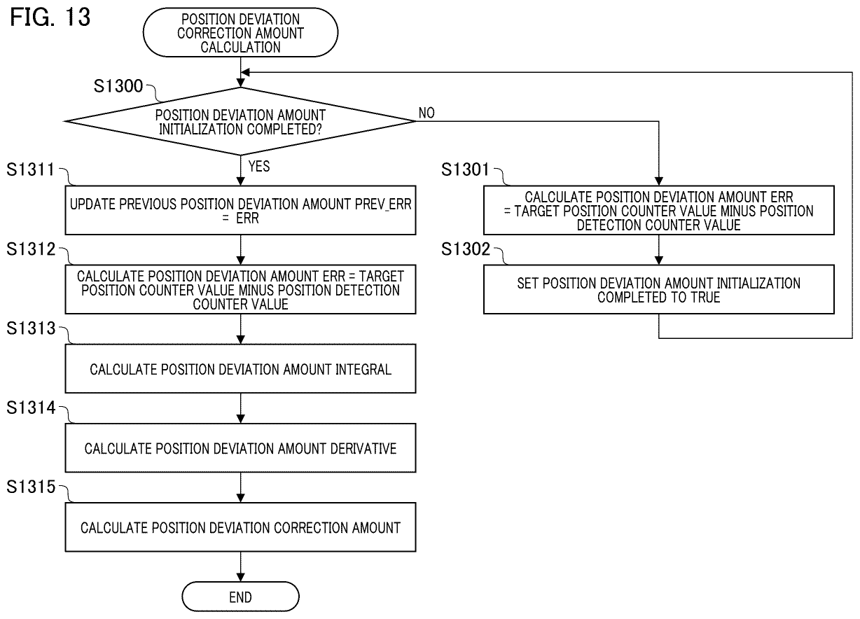

In step S913, when speed deviation adjustment is determined to be completed, in step S914, the position deviation correction amount calculation unit 811 performs calculation of the position deviation correction amount. Here, step S914 functions as a position deviation correction amount calculation step of calculating a position deviation correction amount from a deviation amount between actual position information and a target position counter value. Details of processing in step S914 will be described later with reference to FIG. 13.

Furthermore, in step S915, advance angle correction is performed by the advance angle correction amount calculation unit 812. Thereafter, processing returns to step S900 and advance angle control is continued. Here, step S915 functions as an advance angle correction amount calculation step of converting the position deviation correction amount into a speed deviation correction amount and calculating an advance angle correction amount corresponding to the speed deviation correction amount from correspondence information between speed and advance angle.

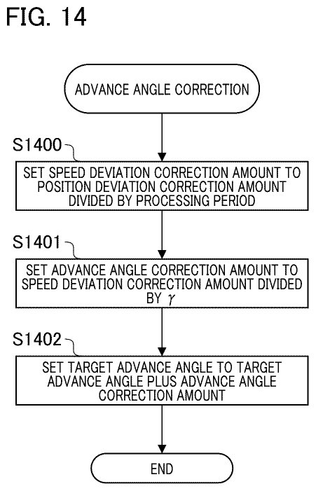

It should be noted that in a case in which it is determined in step S913 that there is no deviation between a moving speed of actual position information and the target speed, advance angle correction processing configured to calculate an advance angle correction amount from the speed deviation correction amount and correct the target advance angle by the advance angle correction amount is executed in step S915. A detailed example of processing in step S915 will be described later with reference to FIG. 14.

Each processing in steps S910 to S912, S914, and S915 described above will be explained using the flowcharts of FIG. 10 to FIG. 14. It should be noted that operations of each step in the flowcharts of FIGS. 10 to 14 are performed sequentially by a CPU serving as a computer in the lens control system executing a computer program stored in memory.

FIG. 10 is a flowchart showing an example of target advance angle calculation processing in step S910. In step S1000 of FIG. 10, whether a target speed has been updated is determined. When it is determined that the target speed has not been updated, target advance angle calculation processing of FIG. 10 is ended, and processing proceeds to step S911 of FIG. 9. In contrast, in a case in which it is determined in step S1000 that the target speed has been updated, processing proceeds to step S1001, and a minimum power rate is selected as a power rate that determines an amplitude of a driving signal.

Next, processing proceeds to step S1002, and processing to calculate a target speed from an inclination of the target position counter value is executed by the target speed calculation unit 801. Here, step S1002 functions as a target speed calculation step that calculates a target speed serving as an amount of change of the target position counter value.

Next, in step S1003, based on equation (1) serving as a relational expression between speed and advance angle, the target advance angle calculation unit 802 calculates a target advance angle corresponding to the target speed calculated in step S1002.

Here, equation (1) serving as the relational expression is prepared for each power rate, and calculation of the target advance angle is performed by selecting a relational expression of a corresponding power rate. Next, in step S1004, whether the target advance angle calculated in step S1003 is within an effective region is determined, and in a case in which the target advance angle is not within the effective region, the processing proceeds to step S1005, a power rate that is one level higher is selected, and the processing returns to step S1003.

Here, “within the effective region” refers to a region in which the relational expression of equation (1) is established, and region R1 in FIG. 5 corresponds to this effective region. In a case in which it is determined in step S1004 that the calculated target advance angle is within the effective region, target advance angle calculation processing of FIG. 10 is completed, and the processing proceeds to step S911, whereupon calculation of a speed deviation adjustment amount is performed.

Next, processing for detecting a deviation between target speed and actual speed and optimizing a relational expression between advance angle and speed will be explained with reference to FIG. 11 and FIG. 12. FIG. 11 is a flowchart showing an example of speed deviation adjustment amount calculation processing in step S911.

In FIG. 11, first, in step S1100, an actual speed serving as an amount of change of actual position information is calculated from an inclination of the position detection counter value. Next, in step S1101, whether initialization of a speed deviation amount has been completed is determined, and if initialization has not been completed, the processing proceeds to step S1102 and initialization processing is performed.

In the initialization processing, in step S1102, a difference between the target speed and the actual speed is calculated as a speed deviation amount, and in step S1103, initialization of the speed deviation amount is set to a completion state, and after the initialization processing of the speed deviation amount is set to the completion state, the processing returns to step S1100.

In contrast, in a case in which it is determined in step S1101 that initialization of the speed deviation amount has been completed, the processing proceeds to step S1112, and after the previous speed deviation amount is updated with a newly calculated speed deviation amount, in step S1113, a difference between the target speed and the actual speed is set as the speed deviation amount. Furthermore, in step S1114, a speed deviation adjustment amount is calculated by multiplying the speed deviation amount by a predetermined gain. Then, the flow of FIG. 11 is ended, and the processing proceeds to step S912 of FIG. 9, whereupon updating of the relational expression is performed.

It should be noted that here the predetermined gain determines adjustment sensitivity of the target advance angle with respect to the speed deviation amount and is set to achieve appropriate responsiveness of speed with respect to advance angle. Furthermore, in a case in which optimization of responsiveness is difficult with only gain, a speed deviation amount may be used as a proportional component and by calculating an integral component and differential component thereof and multiplying coefficients thereto and adding these components together, response characteristics may be adjusted. Alternatively, responsiveness may be adjusted by applying a low-pass filter and/or a high-pass filter to the speed deviation amount.

FIG. 12 is a flowchart showing an example of relational expression update processing in step S912. In step S1200 of FIG. 12, whether a speed deviation adjustment amount calculated in step S911 has entered within ±threshold is determined. In a case in which it is determined in step S1200 that the speed deviation adjustment amount has not entered within ±threshold, the processing proceeds to step S1201.

It should be noted that ±threshold is set taking into consideration a magnitude of periodic variation components of the actual speed of the motor. That is, because the actual speed of the motor varies periodically due to rotation unevenness of the motor itself, eccentricity in mounting of a detection magnet, and shaft runout of the rotation axis 202, and the like, ±threshold may be set by taking into consideration the magnitude of these periodic variation components.

In step S1201, whether or not speed deviation adjustment is being executed is determined. In a case in which speed deviation adjustment is being executed, the processing proceeds to step S1204, and in a case in which speed deviation adjustment is not being executed, the processing proceeds to step S1202. In step S1202, a pre-adjustment actual speed is set to a current actual speed, and a pre-adjustment target advance angle is set to a current target advance angle. Then, in step S1203, a state indicating that speed deviation adjustment is being executed is set.

In step S1204, an advance angle adjustment amount is calculated based on the speed deviation adjustment amount. Here, the advance angle adjustment amount adjusts the target advance angle so that a deviation of actual speed with respect to target speed is eliminated, and because the advance angle adjustment amount is obtained from a movement width (adjustment amount) of advance angle with respect to a movement width (adjustment amount) of speed in equation (1), the advance angle adjustment amount is transformed and calculated by equation (2).

$$Advance angle adjustment amount = speed deviation adjustment amount / γ \qquad Equation ( 2 )$$

It should be noted that γ is identical to inclination γ in equation (1). In this manner, in step S1204, an adjustment amount of the target advance angle corresponding to a speed deviation amount between actual speed and target speed is calculated based on correspondence information between advance angle and speed.

In step S1205, the target advance angle is adjusted by the advance angle adjustment amount calculated in step S1204. That is, the target advance angle becomes (target advance angle+advance angle adjustment amount). Thereafter, the processing returns to step S1200.

Therefore, speed deviation adjustment processing by step S1204 and step S1205 is repeatedly performed until the speed deviation adjustment amount enters within ±threshold in step S1200, whereupon rotation position control of the motor is performed using the adjusted target advance angle.

In contrast, in a case in which it is determined in step S1200 that the speed deviation adjustment amount has entered within ±threshold, the processing proceeds to step S1211, and whether speed deviation adjustment is being executed is determined. In a case in which speed deviation adjustment is not being executed, the flow of FIG. 12 is ended as is and the processing proceeds to step S913.

In a case in which it is determined in step S1211 that speed deviation adjustment is being executed, in step S1212, inclination γ and intercept β of equation (1) are updated. That is, inclination γ and intercept β of equation (1) are updated by equations (3) and (4) using the pre-adjustment actual speed, (post-adjustment) actual speed, pre-adjustment target advance angle, and (post-adjustment) target advance angle.

$$γ = ( actual speed - pre - adjustment actual speed ) / advance angle adjustment amount \qquad Equation ( 3 )$$

$$β = actual speed - ( pre - adjustment target advance angle + advance angle adjustment amount ) \times γ \qquad Equation ( 4 )$$

In this manner, in a case in which the target advance angle has been adjusted in accordance with the speed deviation amount in step S1204 and step S1205, in step S1212, correspondence information between speed and advance angle is corrected and/or updated. After updating relational expression (1) between advance angle and speed in step S1212, in step S1213, speed deviation adjustment being executed is set to FALSE, the flow of FIG. 12 is ended, and the processing proceeds to step S913.

Next, by using the flowcharts of FIG. 13 and FIG. 14, processing examples of position control for detecting a deviation between a target position counter value and a position detection counter value and correcting position deviation will be explained. FIG. 13 is a flowchart showing an example of position deviation correction amount calculation processing in step S914, and FIG. 14 is a flowchart showing an example of advance angle correction processing in step S915.

When it is determined in step S913 of FIG. 9 that speed deviation adjustment is not being executed, position deviation correction amount calculation processing of step S914 is executed in a flow as shown in FIG. 13. First, in step S1300, whether or not initialization of a position deviation amount has been completed is determined.

In a case in which it is determined in step S1300 that initialization of the position deviation amount has not been completed, the processing proceeds to step S1301 and a position deviation amount err is calculated. That is, the position deviation amount err, which is the difference between the target position counter value and the position detection counter value, is calculated.

Next, in step S1302, initialization of the position deviation amount is set to the completion state. Thereafter, the processing returns to step S1300. If it is determined in step S1300 that initialization of the position deviation amount has been completed, the processing proceeds to step S1311, and position deviation correction amount calculation processing is executed.

That is, first, in step S1311, after a previous position deviation amount prev_err is updated to the position deviation amount err calculated in the previous processing, in step S1312, the position deviation amount err is calculated. That is, in step S1312, the position deviation amount err, which is the difference between the target position counter value and the position detection counter value, is calculated.

Next, in step S1313, an integral value of the position deviation amount is calculated. That is, prev_err calculated in step S1311 and err calculated in step S1312 are added together to calculate an integral value int_err of the position deviation amount.

Next, in step S1314, a differential value of the position deviation amount is calculated. That is, prev_err calculated in step S1311 is subtracted from err calculated in step S1312, and a differential value diff_err of the position deviation amount is calculated.

Then, in step S1315, a position deviation correction amount is calculated by using, for example, the following equation (5):

$$Position deviation correction amount = Kp \times err + Ki \times int\_err + Kd \times diff\_err \qquad ( Equation 5 )$$

In this manner, in step S1315, a value obtained by performing weighted addition, using weighting coefficients, of the deviation amount between actual position information and the target position counter value, the differential component of the deviation amount, and the integral component of the deviation amount is set as the position deviation correction amount.

It should be noted that a proportional coefficient Kp, an integral coefficient Ki, and a differential coefficient Kd determine response characteristics of position deviation correction and are arbitrarily set so as to suppress overshoot and deviation when following the target position counter value. That is, each of the above-described weighting coefficients may be set in accordance with responsiveness required for rotation position control of the motor.

In addition, although responsiveness is set here by a combination of difference, integral, and differential, a configuration in which responsiveness is set by a low-pass filter and/or high-pass filter instead of integral and differential may also be acceptable.

That is, a position deviation correction amount may be set by performing weighted addition, using weighting coefficients, of the deviation amount between actual position information and the target position counter value, and at least one result obtained by processing the deviation amount through a low-pass filter or a high-pass filter. It should be noted that filter constants of the above-described low-pass filter and high-pass filter may be set in accordance with responsiveness required for rotation position control of the motor.

After the position deviation correction amount is calculated by step S1315, the flow of FIG. 13 ends, and the processing proceeds to step S915 of FIG. 9, whereupon advance angle correction is performed.

Next, advance angle correction processing in step S915 will be explained using the flowchart of FIG. 14. In step S1400 of FIG. 14, the position deviation correction amount calculated in step S914 is converted into a speed deviation correction amount by performing division by a processing cycle or correction period. In step S1401, an advance angle correction amount is calculated from the speed deviation correction amount using the following equation (6).

$$Advance angle correction amount = speed deviation correction amount / γ \qquad Equation ( 6 )$$

It should be noted that γ is identical to inclination γ in equation (1).

In step S1402, the target advance angle is corrected by adding the advance angle correction amount calculated in step S1401 to the target advance angle. Thereafter, the flow of FIG. 14 ends, and the processing proceeds to step S900 of FIG. 9. In this manner, position control for following the target position counter value is performed by advance angle control as shown in FIG. 9. That is, position control of the driven member is performed using the target advance angle corrected by the advance angle correction amount.

Above, a method according to the First Embodiment for realizing position control that causes an image capturing lens to move by making the image capturing lens follow the counter value of the target position moving at an arbitrary speed by using advance angle control has been explained. According to control of the present embodiment, tracking-type position control that provides high responsiveness and the effect of reducing vibration becomes possible through advance angle control characterized by efficiently rotationally driving the motor.

### Second Embodiment

In the First Embodiment, a method has been explained for performing position control of a driven member using advance angle control, wherein the position control causes the driven member to follow a target position moving at an arbitrary speed. However, in advance angle control, in cases in which motor driving such as acceleration/deceleration having a large speed change is performed, there are cases in which overshoot of an encoder with respect to a target position occurs.

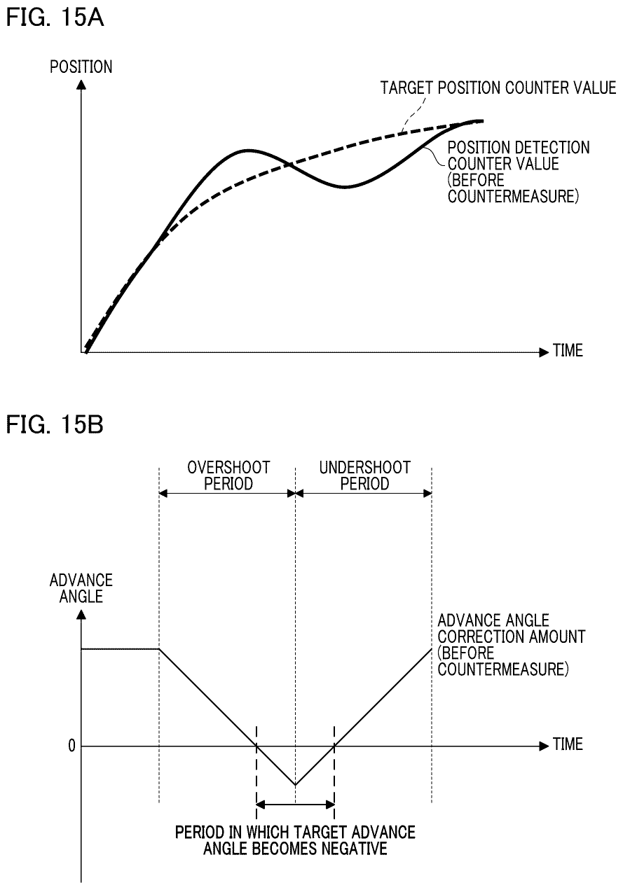

FIG. 15A and FIG. 15B show examples of changes in an encoder and advance angle with respect to a target position counter value according to the First Embodiment. FIG. 15A and FIG. 15B show examples of changes in an encoder and advance angle with respect to a target position counter value in a case in which overshoot occurs during feedback control of advance angle.

In a case in which a speed change of the motor is large, as shown in FIG. 15A, the motor cannot completely follow the target position counter value, and the position detection counter value causes overshoot. At this time, in advance angle correction processing of step S915, as shown in FIG. 15B, advance angle control is performed by correcting the advance angle so as to attenuate the target advance angle and make the motor follow the target position counter value.

However, in a case in which large overshoot occurs, a correction amount of the advance angle also becomes large, and as a result, while the motor is still unable to completely follow the target position counter value, the sign of the target advance angle becomes reversed and undershoot occurs. That is, as shown in FIG. 15B, an interval in which the target advance angle becomes negative occurs, and in a case in which the advance angle is reversed in this manner, the rotation direction of the motor becomes reversed, and as a result, noise is generated.

In addition, in a case in which the First Embodiment is applied to the lens control system, due to reversal of the first zoom lens 102 and the second zoom lens 104, the angle of view change during zooming suddenly becomes discontinuous, or due to reversal of the focus lens 103, focus suddenly becomes greatly misaligned. Therefore, in the Second Embodiment, control is performed so as to prevent reversal of the target advance angle after advance angle correction.

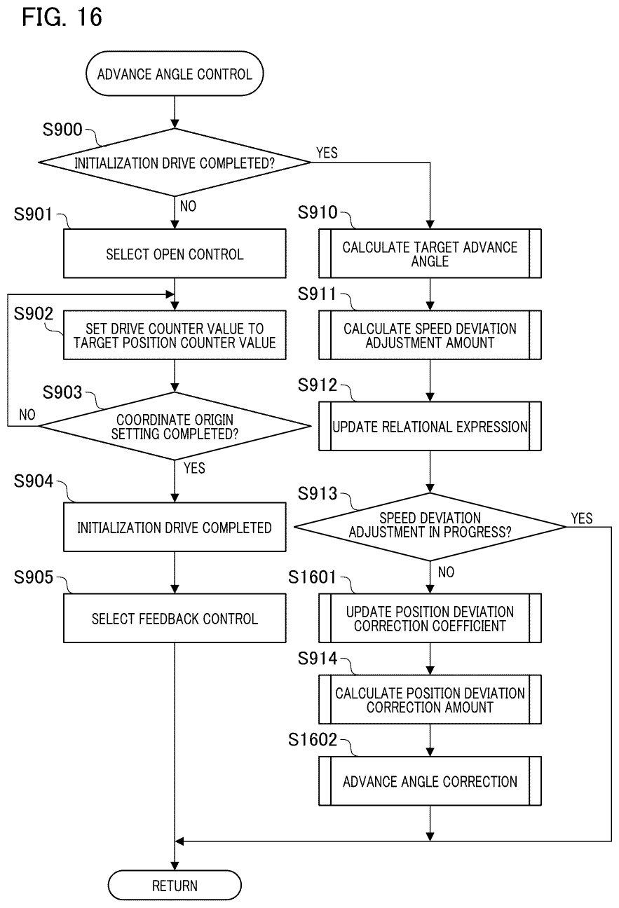

FIG. 16 is a flowchart showing an example of advance angle control in an advance angle control unit 308 according to the Second Embodiment. Operations of each step in the flowchart of FIG. 16 are performed sequentially by a CPU serving as a computer in the lens control system executing a computer program stored in memory.

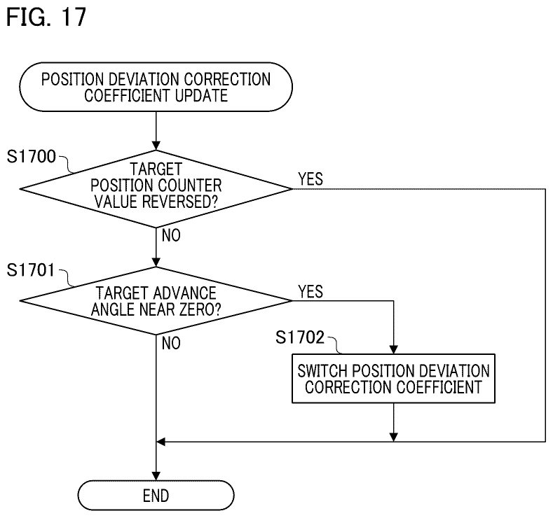

In advance angle control of the Second Embodiment shown in FIG. 16, position deviation correction coefficient update processing in step S1601 has been added to advance angle control of the First Embodiment explained in FIG. 9, and processing of advance angle correction in step S1602 differs. In FIG. 16, because steps having the same reference numerals as in FIG. 9 are identical processing, explanations thereof are omitted. FIG. 17 is a flowchart showing a specific example of position deviation correction coefficient update processing in step S1601.

It should be noted that operations of each step in the flowchart of FIG. 17 are performed sequentially by a CPU serving as a computer in the lens control system executing a computer program stored in memory.

In step S1700 of FIG. 17, whether or not a direction of the target position counter value has been reversed is determined. In a case in which it is determined that the direction of the target position counter value has been reversed, because the motor needs to perform a reversal operation to follow the target position counter value, the position deviation correction coefficient is not updated, the flow of FIG. 17 ends, and the processing proceeds to step S914 of FIG. 16.

In contrast, in a case in which it is determined in step S1700 that the direction of the target position counter value has not been reversed, the processing proceeds to step S1701. In step S1701, whether or not a target advance angle previously set was near zero is determined.

In a case in which “No” is determined in step S1701, the flow of FIG. 17 is ended, and the processing proceeds to step S914 of FIG. 16, whereupon position deviation correction amount calculation is performed. In a case in which “Yes” is determined in step S1701, the processing proceeds to step S1702, and switching of the position deviation correction coefficient is executed.

That is, in a case in which the target advance angle after correction has approached zero, responsiveness of advance angle correction is attenuated. In addition, in step S1702, in order to attenuate responsiveness of advance angle control, proportional coefficient Kp, integral coefficient Ki, and differential coefficient Kd used for calculating a position deviation correction amount in step S914 of FIG. 16 (step S1315 of FIG. 13) are adjusted. Thereafter, the flow of FIG. 17 is ended, the processing proceeds to step S914 of FIG. 16, and position deviation correction amount calculation is performed.

As a method for adjusting each weighting coefficient, for example, a threshold value may be set with respect to advance angle, and in a case in which the advance angle falls below this threshold value, each coefficient may be switched to another coefficient for lowering responsiveness of advance angle correction. Alternatively, weighting coefficients may be adjusted so that each coefficient becomes larger in accordance with a difference between the target position counter value and the position detection counter value. Alternatively, responsiveness of advance angle correction may be changed by a low-pass filter or a high-pass filter instead of adjusting the weighting coefficients.

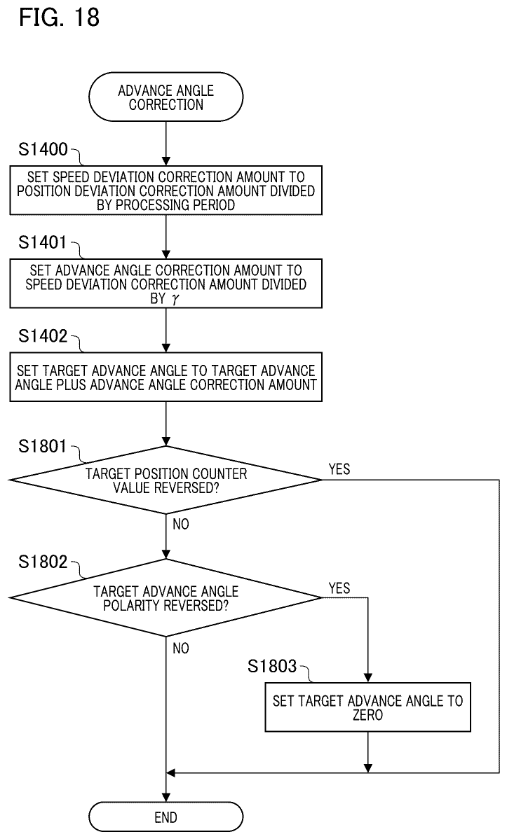

FIG. 18 is a flowchart showing an example of advance angle correction processing in step S1602 according to the Second Embodiment. It should be noted that operations of each step in the flowchart of FIG. 18 are performed sequentially by a CPU and the like serving as a computer in the lens control system executing a computer program stored in memory.

In the advance angle processing of step S1602 of the Second Embodiment, compared to the advance angle correction processing of step S915 according to the First Embodiment explained in FIG. 14, the advance angle reversal prevention processing of steps S1801 to S1803 is added. In FIG. 18, because steps having the same reference numerals as in FIG. 14 denote identical processing, explanations thereof are omitted.

For advance angle reversal prevention processing, in step S1801 of FIG. 18, whether a direction of the target position counter value is reversed is determined. In a case in which it is determined in step S1801 that the direction of the target position counter value has been reversed, because a reversal operation is necessary for the motor to follow the target position counter value, advance angle reversal prevention processing is not performed and the flow of FIG. 18 is ended.

That is, in a case in which the advancing direction of the target position counter value is reversed, neither the processing for attenuating responsiveness of advance angle correction nor the processing for limiting the target advance angle to zero is performed. In contrast, in a case in which it is determined in step S1801 that the direction of the target position counter value has not been reversed, the processing proceeds to step S1802.

In step S1802, whether or not polarity of the target advance angle is reversed is determined. In a case in which it is determined in step S1802 that polarity of the target advance angle is not reversed, the flow of FIG. 18 is ended. In contrast, in a case in which it is determined in step S1802 that polarity of the target advance angle has been reversed, in step S1803, a value of the target advance angle is limited to zero. That is, in a case in which polarity of the target advance angle is reversed, the target advance angle is limited to zero, and thereafter, the flow of FIG. 18 is ended.

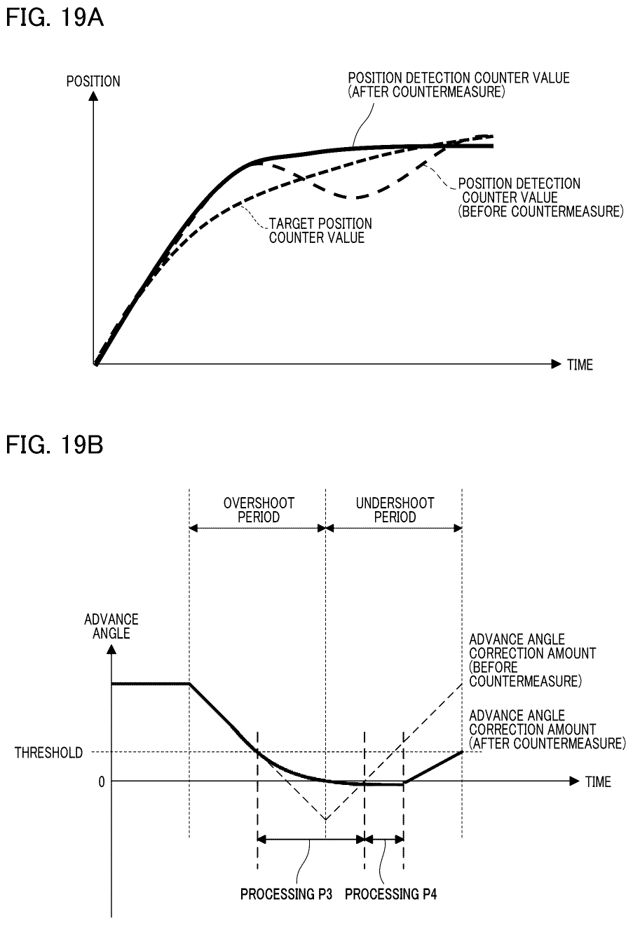

FIG. 19A and FIG. 19B are figures showing examples of changes in an encoder and advance angle in a case in which reversal prevention processing according to the Second Embodiment is applied. That is, FIG. 19A and FIG. 19B show relationships between actual position and advance angle with respect to a target position counter value in a case in which position deviation correction coefficient update processing and advance angle reversal prevention processing for reversal prevention according to the Second Embodiment are performed.

In processing P3 corresponding to step S1702, in a case in which the target advance angle has approached near zero, the target advance angle is attenuated by switching correction coefficients in position deviation correction coefficient update processing. In association with this, rotation speed of the motor gradually decreases, and the position detection counter value indicating actual position gradually follows the target position.

Next, in processing P4 corresponding to step S1803, in a case in which the target advance angle after correction crosses zero, the target advance angle is limited to zero. As a result of limiting the target advance angle to zero, the motor stops and the position detection counter value continues to maintain the position at which the motor stopped. When interval P4 is exited, the target advance angle starts to increase, and in accordance with the increase in the target advance angle, the motor also restarts rotation, whereupon the position detection counter value follows the target position.

As explained above, in the Second Embodiment of the present invention, in the advance angle reversal prevention processing of step S1802, in a case in which a sign of the target advance angle after correction is reversed, the target advance angle is limited to zero. Therefore, the motor does not reverse until reaching the target position, making it possible to avoid noise due to motor reversal.

In addition, because responsiveness of advance angle feedback control is attenuated as the target advance angle approaches zero, sudden stopping of the motor is suppressed, making it possible to avoid noise due to sudden stopping of the motor. Furthermore, in a case in which the embodiment is applied to the lens control system, phenomena such as an angle of view change during zooming suddenly becoming discontinuous or focus suddenly becoming greatly misaligned can be avoided.

It should be noted that as described above, in order to suppress overshoot and undershoot as shown in FIG. 15, responsiveness of position deviation correction and advance angle correction may be attenuated by using a low-pass filter and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the motor control apparatus and the like through a network or various storage media. Then, a computer (or a CPU, an MPU, or the like) of the motor control apparatus and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-065018, filed on Apr. 12, 2024, which is hereby incorporated by reference herein in its entirety.

What is claimed is:

1. A motor control apparatus comprising at least one processor or circuit configured to function as:
an encoding unit configured to detect a rotation state of a motor and convert the rotation state into actual position information;
a target position setting unit configured to generate a target position counter value that serves as a movement target of a driven member connected to the motor; and
an advance angle control unit configured to control a rotation speed of the motor based on a target advance angle, wherein
the advance angle control unit comprises:
a target speed calculation unit configured to calculate a target speed that is an amount of change of the target position counter value;
a target advance angle calculation unit configured to calculate the target advance angle corresponding to the target speed based on correspondence information between the rotation speed and the advance angle;
a position deviation correction amount calculation unit configured to calculate a position deviation correction amount from a deviation amount between the actual position information and the target position counter value; and
an advance angle correction amount calculation unit configured to convert the position deviation correction amount into a speed deviation correction amount and calculate an advance angle correction amount corresponding to the speed deviation correction amount from the correspondence information between the rotation speed and the advance angle, and
wherein position control of the driven member is performed using the target advance angle corrected by the advance angle correction amount.

2. The motor control apparatus according to claim 1, wherein the target advance angle calculation unit is configured to:
calculate an actual speed that is an amount of change of the actual position information,
calculate an adjustment amount of the target advance angle corresponding to a speed deviation amount between the actual speed and the target speed based on correspondence information between the rotation speed and the advance angle, and
perform rotation position control of the motor using the adjusted target advance angle.

3. The motor control apparatus according to claim 1, wherein the speed deviation correction amount is obtained by dividing the position deviation correction amount by a cycle of correction processing or a correction period.

4. The motor control apparatus according to claim 1, wherein advance angle correction processing configured to calculate the advance angle correction amount from the speed deviation correction amount and to correct the target advance angle by the advance angle correction amount is executed in a case in which it is determined that there is no deviation between a moving speed of the actual position information and the target speed.

5. The motor control apparatus according to claim 1, wherein in a case in which the target advance angle has been adjusted corresponding to the speed deviation amount, the correspondence information between the rotation speed and the advance angle is corrected and/or updated.

6. The motor control apparatus according to claim 1, wherein the correspondence information between the rotation speed and the advance angle is a relational expression or previously stored table data that indicates a correspondence relationship between the advance angle and the rotation speed.

7. The motor control apparatus according to claim 1, wherein the advance angle control unit is configured to set, as the position deviation correction amount, a value obtained by weighted addition, using weighting coefficients, of the deviation amount between the actual position information and the target position counter value, a differential component of the deviation amount, and an integral component of the deviation amount.

8. The motor control apparatus according to claim 1, wherein the advance angle control unit is configured to set as the position deviation correction amount a value obtained by weighted addition, using weighting coefficients, of the deviation amount between the actual position information and the target position counter value and at least one of a result obtained by processing the deviation amount by a low-pass filter and a result obtained by processing the deviation amount by a high-pass filter.

9. The motor control apparatus according to claim 8, wherein responsiveness of advance angle correction is changed by the weighting coefficients, the low-pass filter, or the high-pass filter.

10. The motor control apparatus according to claim 1, wherein the advance angle control unit is configured to attenuate responsiveness of advance angle correction in a case in which the target advance angle after correction approaches zero.

11. The motor control apparatus according to claim 1, wherein the advance angle control unit is configured to limit the target advance angle to zero in a case in which polarity of the target advance angle is reversed.

12. The motor control apparatus according to claim 1, wherein in a case in which an advancing direction of the target position counter value is reversed, neither processing for attenuating responsiveness of advance angle correction nor processing for limiting the target advance angle to zero is performed.

13. A motor control apparatus comprising:
an image capturing lens configured to perform magnification variation by moving a plurality of lenses in conjunction with each other in a predetermined positional relationship;
motors configured to drive each of the lenses configuring the image capturing lens; and
at least one processor or circuit configured to function as:
an encoding unit configured to detect a rotation state of each motor and convert the rotation state into actual position information;
a target position setting unit configured to generate a target position counter value serving as a movement target for each lens connected to a motor; and
an advance angle control unit configured to control rotation speed based on a target advance angle, wherein the advance angle control unit comprises:
a target speed calculation unit configured to calculate a target speed that is an amount of change of the target position counter value;
a target advance angle calculation unit configured to calculate the target advance angle corresponding to the target speed based on correspondence information between the rotation speed and the advance angle;
a position deviation correction amount calculation unit configured to calculate a position deviation correction amount from a deviation amount between the actual position information and the target position counter value; and
an advance angle correction amount calculation unit configured to convert the position deviation correction amount into a speed deviation correction amount and calculate an advance angle correction amount corresponding to the speed deviation correction amount from the correspondence information between the rotation speed and the advance angle, and
wherein position control of each lens is performed using the target advance angle corrected by the advance angle correction amount.

14. The motor control apparatus according to claim 13, wherein the image capturing lens comprises at least one zoom lens and a focus lens,
the target position counter value of at least one of the zoom lens is generated so that the zoom lens moves at the target speed, and
the target position counter value of the focus lens is generated so that the focus lens moves following a predetermined trajectory in conjunction with movement of the zoom lens.

15. A motor control method comprising:
detecting a rotation state of a motor and converting the rotation state into actual position information;
generating a target position counter value serving as a movement target of a driven member connected to the motor;
controlling a rotation speed of the motor based on a target advance angle; and
in advance angle control:
calculating a target speed that is an amount of change of the target position counter value;
calculating the target advance angle corresponding to the target speed based on correspondence information between the rotation speed and the advance angle;
calculating a position deviation correction amount from a deviation amount between the actual position information and the target position counter value;
converting the position deviation correction amount into a speed deviation correction amount and calculating an advance angle correction amount corresponding to the speed deviation correction amount from the correspondence information between the rotation speed and the advance angle; and
performing position control of the driven member using the target advance angle corrected by the advance angle correction amount.

16. A non-transitory computer-readable storage medium storing a computer program including instructions for executing following processes:
detecting a rotation state of a motor and converting the rotation state into actual position information;
generating a target position counter value serving as a movement target of a driven member connected to the motor;
controlling a rotation speed of the motor based on a target advance angle;
in advance angle control:
calculating a target speed that is an amount of change of the target position counter value;
calculating the target advance angle corresponding to the target speed based on correspondence information between the rotation speed and the advance angle;
calculating a position deviation correction amount from a deviation amount between the actual position information and the target position counter value;
converting the position deviation correction amount into a speed deviation correction amount and calculating an advance angle correction amount corresponding to the speed deviation correction amount from the correspondence information between the rotation speed and the advance angle; and
performing position control of the driven member using the target advance angle corrected by the advance angle correction amount.
